(19) United States
(12) Patent Application Publication
(10) Pub. No.: US 2018/0313722 A1
(43) Pub. Date: Nov. 1, 2018

(54) Protective Structure For Outdoor Installation of Drive-Over Tire Inspection System

(71) Applicant: Hunter Engineering Company, St. Louis, MO (US)

(72) Inventor: Michael T. Stieff, Wentzville, MO (US)

(21) Appl. No.: 15/962,836

(22) Filed: Apr. 25, 2018

Related U.S. Application Data
(60) Provisional application No. 62/490,277, filed on Apr. 26, 2017.

(51) Int. Cl. G01M 17/02; G01B 21/18

(52) U.S. Cl. CPC G01M 17/02; G01B 21/18

(57) ABSTRACT

A protective structure for an outdoor installation of a drive-over tire inspection system. The protective structure consists of a base incorporating approach and departure ramps, vehicle guides on each side of the respective ramps, a pair of sensor receiving recesses centrally disposed between the ramps, and at least one channel for draining water from within the sensor receiving recesses. A drainage channel and a conduit for the routing of data communication cables, power cables, and trigger signal cables connects the sensor receiving recesses. Optionally, protective bollards are disposed in proximity to the corners or sides of the protective structure, guiding vehicles onto the approach and departure ramps, and to prevent vehicles from crossing over the protective structure in unintended directions.

### CROSS-REFERENCE TO RELATED APPLICATIONS

The present application is related to, and claims priority from, co-pending U.S. Provisional Patent Application Ser. No. 62/490,277 filed on Apr. 26, 2017, and which is herein incorporated by reference.

### STATEMENT REGARDING FEDERALLY SPONSORED RESEARCH

Not Applicable.

### BACKGROUND OF THE INVENTION

The present application is related to drive-through vehicle inspection stations, and in particular, to a protective structure for an outdoor installation of a drive-over tire inspection system.

Drive-through or drive-over vehicle inspection systems offer vehicle operators an opportunity to complete an inspection of one or more parameters of a vehicle without the need for the operator to leave the vehicle, stop the vehicle, or shut off the vehicle for an extended period of time while measurements of the vehicle are acquired. Drive-through or drive-over inspection systems are particularly suited for installation in areas of controlled high-volume traffic, such as an entrance to a parking structure, refueling station, or vehicle service facility. An exemplary drive-through or drive-over vehicle inspection system is a tire tread depth inspection system, such as shown in U.S. Pat. No. 9,046,446 B1 to Carroll et al. Sensors for illuminating and observing tire tread surfaces are disposed within contained units placed in-line with the vehicle tire paths, together with suitable trigger systems. Vehicles passing over the tire tread depth inspection system activate the trigger systems, which in turn activate the tread depth measurement components of the sensors at the appropriate time to acquire measurement data representative of the tire tread surfaces for each passing wheel of the vehicle. Subsequent processing of the acquired measurement data identifies remaining tread depth values for the observed tires, and which is subsequently displayed or communicated to the vehicle operator in a suitable manner, such as by a visual display, electronic message, or printed report.

When installed inside of a vehicle service facility, drive-through or drive-over vehicle inspection systems are generally protected against adverse environmental conditions and risk of damage from improper vehicular traffic. However, outdoor installations are generally exposed to a wider range of environmental conditions, including flooding from rain or snow, and accumulation of debris such as dirt, leaves, and de-icing products in recessed or exposed area. Furthermore, outdoor installations may be at greater risk of damage from improper vehicle traffic, such as oversized vehicles, vehicles traveling in a direction other than that which was intended for use of the inspection system, and roadway service equipment such as snow plows or street cleaners.

Accordingly, there is a need for installed protective structures suitable for use with a drive-through or drive-over vehicle inspection system, such as a tire inspection system. It would be advantageous to provide such a protective structure which affords a measure of protection for the tire inspection system against both adverse environmental conditions and improper vehicular traffic. It would be further advantageous to provide such a protective structure which may be installed on a wide range of surfaces, without a need for extensive sub-surface excavation, and which may be subsequently removed without significantly damaging underlying surfaces, but which is sufficiently robust so as to withstand environmental exposure and vehicular traffic.

### BRIEF SUMMARY OF THE INVENTION

In one embodiment, the present disclosure sets forth a protective structure for an outdoor installation of a drive-over tire inspection system. The protective structure consists of a base for placement on an existing surface, such as a paved parking lot, roadway, or on a prepared surface, such as compacted gravel. The base incorporate an approach ramp and a departure ramp, vehicle guides on each side of the respective ramps, a pair of sensor receiving recesses centrally disposed between the ramps, and at least one channel for draining water from within the sensor receiving recesses. The sensor receiving recesses may be connected by a common drainage channel, as well as a conduit for routing of data communication cables, power cables, and trigger signal cables. A set of protective bollards may optionally be disposed in proximity to the corners or sides of the protective structure, to guide vehicles onto the approach and departure ramps, and to prevent vehicles from crossing over the protective structure in unintended directions.

In a further embodiment, the protective structure is formed from poured concrete, asphalt, or a combination of poured concrete and asphalt.

In yet another embodiment, the protective structure is formed from a set of pre-cast concrete components.

In an additional embodiment, the protective structure is provided with an awning or pavilion-style roof to reduce direct exposure to rain, snow and sunlight.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is an exemplary illustration of an outdoor installation of a drive-over tire inspection system with a protective structure of the present disclosure;

FIG. 2 is a perspective view of the protective structure of FIG. 1;

FIG. 3 is a side plan view of the protective structure of FIG. 2;

FIG. 4 is a perspective view of a pre-formed mold for use in forming the recessed region within the sensor platform;

FIG. 5 is a top side perspective view of the protective structure of FIG. 2, with a pair of tire inspection systems shown as installed; and

FIG. 6 is an exemplary illustration of a covered outdoor installation of a dual lane drive-through tire inspection kiosk incorporating a pair of protective structures of the present disclosure.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

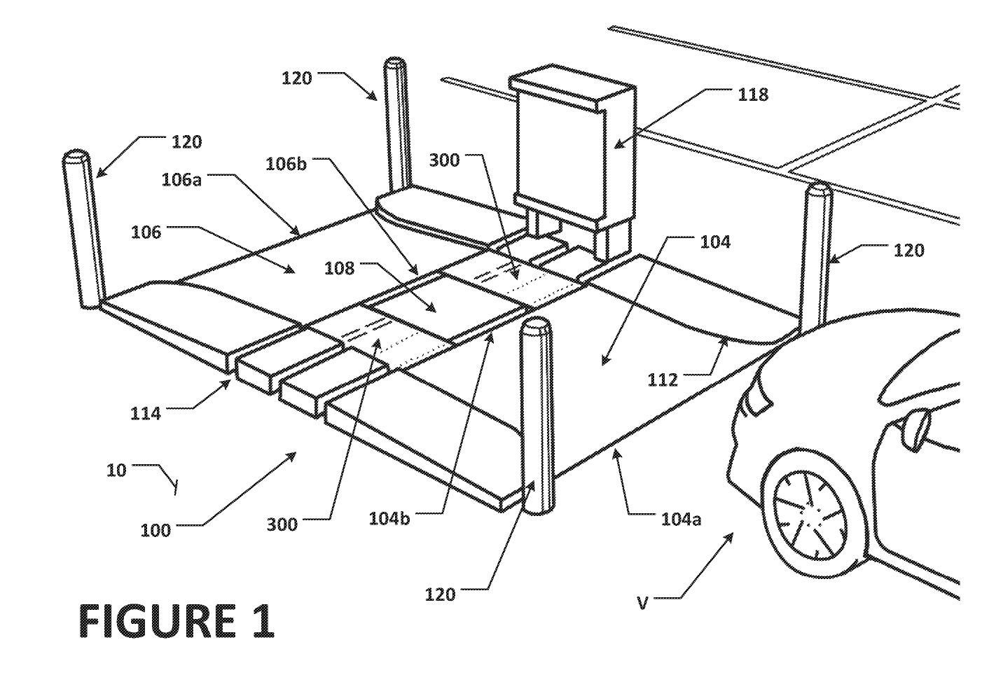

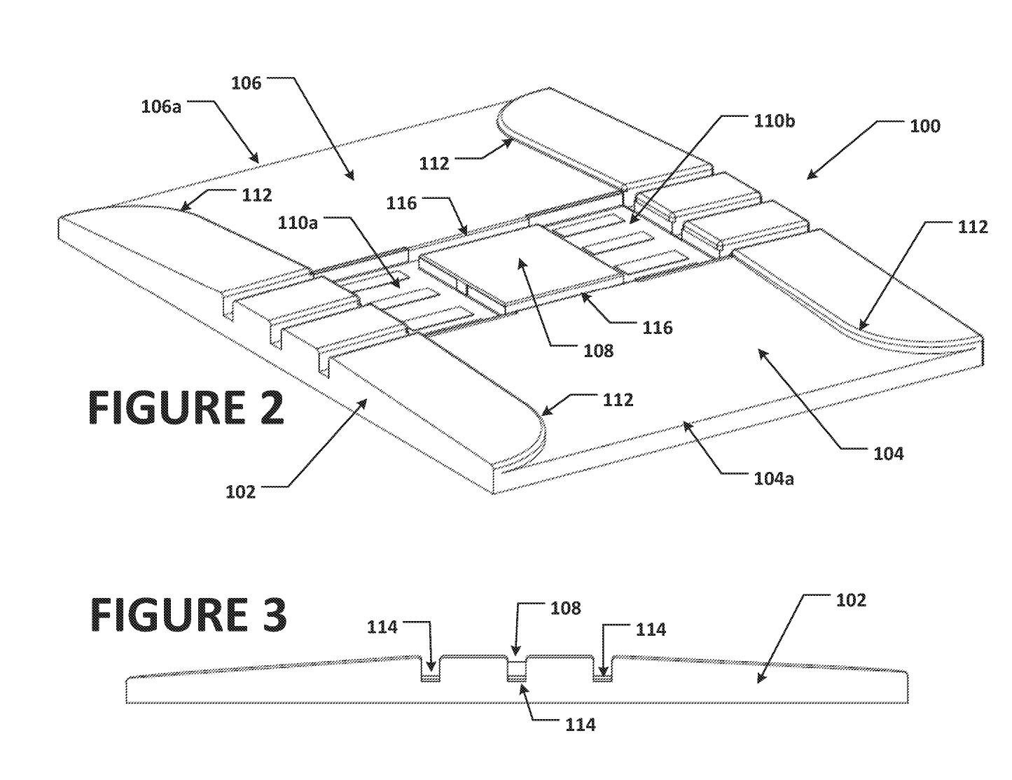

Turning to the figures, and to FIGS. 1-3 in particular, a protective structure of the present disclosure for an outdoor installation of a drive-over tire inspection system is shown generally at 100. The protective structure 100 consists of a base 102 for installation on an existing surface 10, such as a paved parking lot, roadway, or on a prepared surface, such as compacted gravel. The base 102 incorporates an approach ramp 104 typically inclined upward from an outer longitudinal end 104a towards a longitudinal inner end 104b, and a departure ramp 106 typically inclined opposite the approach ramp 104 between an outer longitudinal end 106a and an inner longitudinal end 106b. It will be recognized that the specific inclination of the approach ramp 104 and the departure ramp 106 is not limited in any manner so long as suitable pathways for water drainage from the relevant areas are provided as described below. For example, a typical installation on a sloped surface may have the approach ramp included upward (or even level) relative to the sloped surface, and the departure ramp inclined in the same direction. Optionally, one or both of the ramps may include a lateral slope as well as the aforementioned longitudinal slope, facilitating water drainage to one or both sides. A sensor platform 108 is disposed between the ramps 104, 106, having an upper surface which is generally vertically aligned the longitudinally inward ends of each ramp 104, 106. In cold-weather climates, the upper surface of the sensor platform 108 may be elevated above the inward ends 104a, 106a of the approach and departure ramps 104, 106 so as to deflect snow plow blades up and over sensors installed within the protective structure 100. Additionally, in cold-weather climates, a suitable snow-melt heating system (not shown), such as a thermo-electric heating grid or warm-water circulating tubing may be incorporated into the base 102 to keep the exposed surfaces free of accumulating ice and snow.

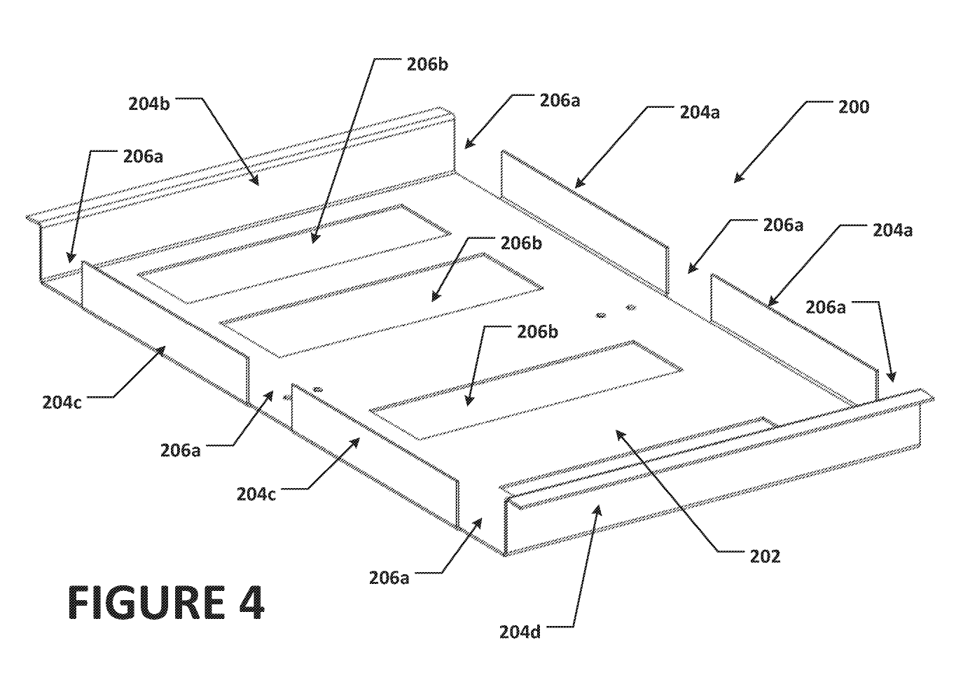

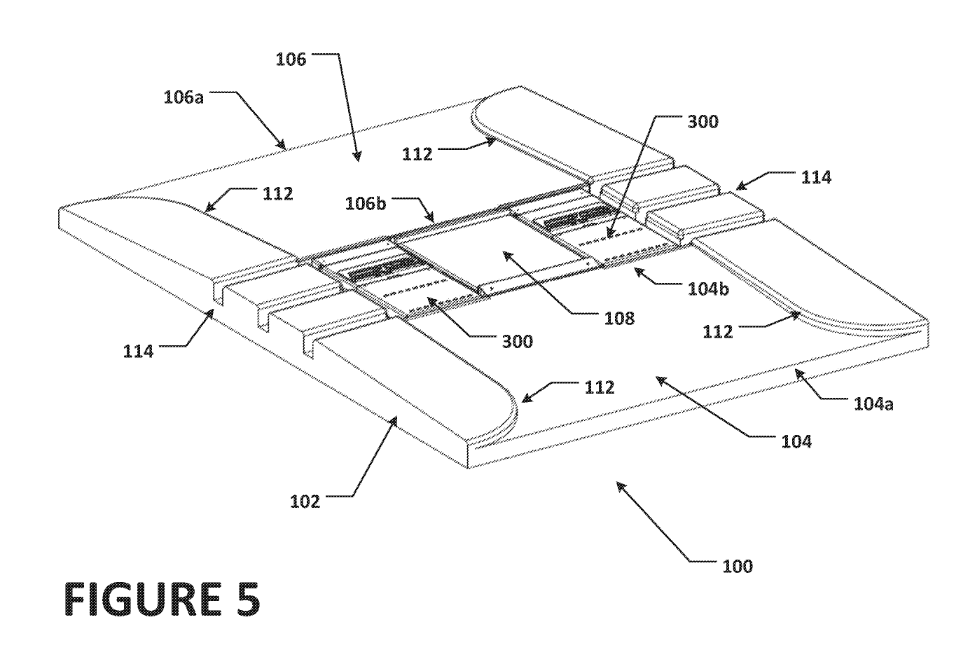

As best shown in FIG. 2, the sensor platform includes a pair of recesses 110a, 110b for receiving drive-over tire tread depth sensor modules 300, such as the Quick Tread™ tire tread depth sensors sold by Hunter Engineering Company of St. Louis, Mo. The recesses 110a, 110b are laterally spaced on opposite sides of a longitudinal centerline of the base 102 to align with an intended range of track-widths for vehicles crossing the sensor platform 108. The recesses may be formed directly into the material of the base 102, or independently using pre-formed components installed within the base 102. For example, each recess may be defined by a pre-formed stainless steel form 200 having a floor 202 and four sidewalls 204a-d as shown in FIG. 4. The height of the sidewalls 204a-d corresponds to the depth of the recess. Appropriate openings 206a through the sidewalls and openings 206b through the floor may be included to provide for drainage, attachment points, and/or anchor bolts. The depth of each recess 110a, 110b is limited to ensure the floor surface of each sensor module recess is elevated above the existing surface 10, facilitating drainage. Raised vehicle guide edges 112 on each side of the respective ramps 104, 106 assist in generally directing vehicles to steer along the longitudinal centerline of the base 102 when traversing the ramps 104, 106 and sensor platform 108, such that the vehicle tires will cross the sensor modules 300 disposed within the sensor module receiving recesses 110a, 110b.

Since the protective structure 100 is intended for outdoor installation, it is necessary to provide a means for drainage of accumulated water from within the sensor module recesses 110a, 110b. At least one channel 114 extends laterally from each sensor module recess to a lateral side edge of the base 102, sloped to permit drainage from the associated sensor module recess onto the surface 10. Preferably, a plurality of channels 114 are provided for each sensor module recess 110, as shown in the figures. One or more channels 116 may further connect sensor module recesses 110A and 110B, as may one or more cable conduits (not shown) may optionally be concealed beneath the surface of the sensor platform 108. The cable conduits are configured for routing of data communication cables, power cables, and trigger signal cables between the sensor modules 300 within the recesses, as well as to external control systems or junction boxes 118.

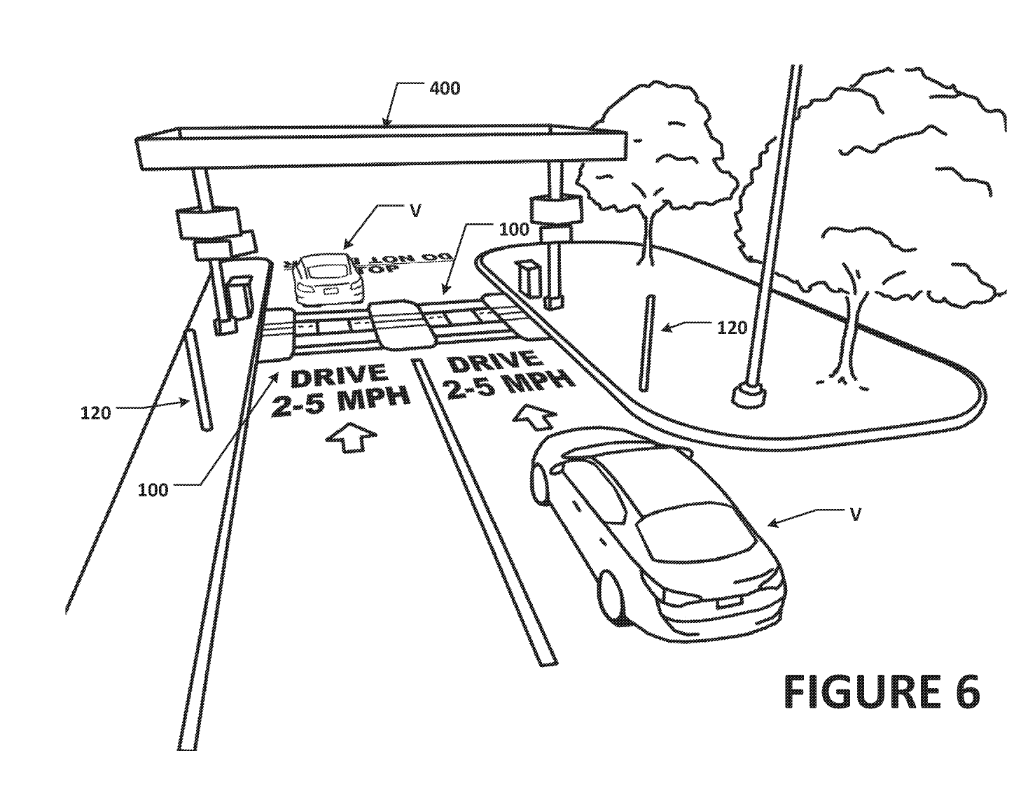

Optionally, as seen in FIGS. 1 and 6, a set of protective bollards 120 disposed in proximity to the corners or sides of the protective structure 100 guides approaching and departing vehicles onto the approach and departure ramps 104, 106, and prevents vehicles from crossing over the protective structure in unintended directions.

Preferably, the base 102, including the ramps 104, 106, and sensor platform 108, together with the associated recesses 110, edges 112, and channels 114, 116 are formed in-situ on the surface 10 from poured concrete using conventional concrete forming techniques. A temporary or permanent guide, pan, or mold, such as the stainless steel form 200 shown in FIG. 4 may be utilized to facilitate proper placement and dimensions of the various formed features of the base 102. Those of ordinary skill will further recognize that the various parts of which comprise the base 102 may be individually pre-cast in concrete, and fitted together on site using suitable concrete joining techniques, such as an epoxy adhesive. Alternatively, the base 102 may be formed from asphalt or from a combination of poured concrete and asphalt.

In an additional embodiment, as illustrated in FIG. 6, the protective structure is provided with an awning or pavilion-style roof 300 to reduce direct exposure to rain, snow and sunlight. Additionally shown in FIG. 6, multiple protective structures 100 may be disposed in close proximity, such as across multiple lanes of a roadway. In FIG. 6, a pair of adjacent protective structures 100 are disposed in a side-by-side configuration across the entrance to a parking facility, beneath a shared roof structure 300, such that vehicles entering into the parking facility will pass over one of the two protective structures 100. Optionally, other environmental protection features, such as heating elements may be incorporated into the protective structures 100 without departing from the scope of the invention.

As various changes could be made in the above constructions without departing from the scope of the disclosure, it is intended that all matter contained in the above description or shown in the accompanying drawings shall be interpreted as illustrative and not in a limiting sense.

1. A protective structure for an outdoor installation of a drive-over tire inspection system on an existing surface, comprising:
an approach ramp extending from a first outer longitudinal end towards a first longitudinal inner end;
a departure ramp spaced longitudinally from said approach ramp, said departure ramp extending between a second outer longitudinal end and a second inner longitudinal end facing said first inner longitudinal end;
a sensor platform segment disposed between said first and second inner longitudinal ends of the approach and departure ramps; and
wherein said sensor platform segment includes a pair of recesses, each recess configured to receive a drive-over tire tread depth sensor module in flush alignment with said first inner longitudinal end and said second inner longitudinal end, said recesses in said pair laterally spaced apart on opposite sides of a longitudinal centerline of the sensor platform to encompass an intended range of track widths for vehicles crossing the sensor platform.

2. The protective structure of claim 1 wherein said approach ramp is inclined upward from said first outer longitudinal end towards said first longitudinal inner end.

3. The protective structure of claim 1 wherein said departure ramp is inclined upward from said second outer longitudinal end towards said second longitudinal inner end.

4. The protective structure of claim 1 wherein said sensor platform segment includes an upper surface vertically aligned with the longitudinally inward ends of said approach and departure ramps.

5. The protective structure of claim 1 wherein said sensor platform segment includes an upper surface elevated above the longitudinally inward ends of said approach and departure ramps.

6. The protective structure of claim 1 wherein each recess in said pair includes a floor surface elevated above the existing surface.

7. The protective structure of claim 1 wherein each of said approach and departure ramps further includes a vehicle guide adjacent each lateral side of the respective ramps, each of said vehicle guides configured with a raised edge to assist in directing vehicles to steer along the longitudinal centerline when traversing said ramps and said sensor platform segment.

8. The protective structure of claim 1 further including a means for drainage of accumulated water from within the pair of recesses in said sensor platform segment.

9. The protective structure of claim 8 wherein said means for drainage includes at least one channel extending laterally from each of said recesses to an adjacent lateral side edge of the sensor platform segment, each channel sloped to facilitate drainage away from the associated recess.

10. The protective structure of claim 1 further including a cable conduit contained within said sensor platform segment, said cable conduit extending between said pair of recesses and at least one lateral side of said sensor platform segment.

11. The protective structure of claim 1 wherein said approach ramp, said departure ramp, and said sensor platform segment are formed from at least one of poured concrete, cast concrete, or compressed asphalt.

12. The protective structure of claim 1 wherein said approach ramp, said departure ramp, and said sensor platform segment are formed from individually pre-cast concrete sections.

13. A drive-over apparatus for facilitating measurement of tire tread depth on the wheels of a vehicle in an outdoor location, comprising:
a protective structure including
an approach ramp inclined upward from a first outer longitudinal end towards a first longitudinal inner end;
a departure ramp spaced longitudinally from said approach ramp, said departure ramp inclined upward between a second outer longitudinal end and a second inner longitudinal end;
a sensor platform segment disposed between said first and second inner longitudinal ends of the approach and departure ramps, said sensor platform segment having an upper surface;
wherein said sensor platform segment further includes a pair of recesses each having a floor surface elevated above the existing surface for receiving drive-over tire tread depth sensors in flush alignment with said first and second inner longitudinal ends of the ramps, said recesses laterally spaced apart on opposite sides of a longitudinal centerline of the sensor platform to encompass an intended range of track widths for vehicles crossing the sensor platform; and
a drive-over tire tread depth sensor module operatively disposed within each recess of said pair of recesses, each drive-over tire tread depth sensor module coupled to a source of electrical power and in communication with a processing system configured with software instructions for receiving tire tread depth data, processing tire tread depth data, and reporting tire tread depth measurement results.

14. The drive-over apparatus of claim 13 wherein each of said approach and departure ramps further include a vehicle guide structure on each lateral side of the respective ramps to assist in directing vehicles to steer along the longitudinal centerline when traversing said ramps and said sensor platform segment.

15. The drive-over apparatus of claim 13 further including at least one drainage channel for discharge of water from within the pair of recesses in said sensor platform segment.

16. The drive-over apparatus of claim 13 further including a cable conduit contained within said sensor platform segment, said cable conduit extending between said pair of recesses and at least one lateral side of said sensor platform segment.

17. The drive-over apparatus of claim 13 wherein said approach ramp, said departure ramp, and said sensor platform segment are formed from at least one of poured concrete, cast concrete, and asphalt.

18. The drive-over apparatus of claim 13 further including a roof structure disposed over at least said sensor platform segment, said roof structure having sufficient height to permit passage of a vehicle over said sensor platform segment.

19. The drive-over apparatus of claim 13 wherein said protective structure incorporates heating elements configured to facilitate melting of snow and ice accumulations on exposed surfaces of one or more of said approach ramp, said departure ramp, and said sensor platform.

20. A fixture for supporting a pair of drive-over tire tread depth sensor modules, comprising:
a sensor platform including
a pair of recesses laterally spaced on opposite sides of longitudinal centerline of said sensor platform, each recess configured to receive a drive-over tire tread depth sensor module, and
at least one drainage channel connected to each recess, each drainage channel configured to drain water away from an associated recess;
an approach ramp extending in a direction of intended vehicle travel over said drive-over tire tread depth sensor modules installed within each of said recesses, from a first outer longitudinal end towards said sensor platform, said approach ramp having a lateral width equal to or greater than the lateral spacing of said pair of recesses;
a departure ramp extending in a direction of intended vehicle travel away from said drive-over tire tread depth sensor modules, from said sensor platform towards a second outer longitudinal end, said departure ramp having a lateral width equal to or greater than the lateral spacing of said pair of recesses; and
wherein said sensor platform, said approach ramp, and said departure ramp are formed from at least one of concrete or compressed asphalt.
